(19) United States
(12) Patent Application Publication
(10) Pub. No.: US 2026/0189496 A1
(43) Pub. Date: Jul. 2, 2026

(54) METHOD, SYSTEM, AND STORAGE MEDIUM OF VIRTUAL NETWORK FUNCTION PLACEMENT FOR MAPPING SERVICE FUNCTION CHAIN REQUESTS IN CLOUD NETWORK

(71) Applicant: Intelligent Fusion Technology, Inc., Germantown, MD (US)

(72) Inventors: Xin TIAN, Germantown, MD (US); Duo XU, Germantown, MD (US); Khanh PHAM, Albuquerque, NM (US); Erik BLASCH, Arlington, VA (US); Genshe CHEN, Germantown, MD (US)

(21) Appl. No.: 18/791,661

(22) Filed: Aug. 1, 2024

(51) Int. Cl. H04L 45/121

(52) U.S. Cl. CPC H04L 45/121

(57) ABSTRACT

A method of virtual network function (VNF) placement for mapping service function chain requests (SFCRs) includes, at the node mapping stage, receiving a SFCR including a plurality of virtual network function requests (VNFRs) from a user, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type on the second best-ranked server node, and placing the VNFR onto the second best-ranked server node; and after placing the VNFR onto the first or second best-ranked server node, selecting a source node for video synchronization.

### GOVERNMENT RIGHTS

The present disclosure was made with Government support under Contract No. FA9453-23-P-A048, awarded by the United States Air Force. The U.S. Government has certain rights in the present disclosure.

### FIELD OF THE DISCLOSURE

The present disclosure generally relates to the field of cloud network technology and, more particularly, relates to a method, a system, and a storage medium of virtual network function (VNF) placement for mapping service function chain requests (SFCRs) in a cloud network.

### BACKGROUND

The great progress in aviation, new energy and artificial intelligence (AI) technologies has led to rapid development of unmanned aerial vehicles (UAVs). UAVs can acquire images and videos in real time by carried video sensors. Meanwhile, UAVs compress and encode multimedia and finally upload the multimedia through wireless networks. Such manner of real-time imaging and transmission makes UAVs play a great role in various fields, such as land mapping, pollution monitoring, disaster management, and personal aerial photography.

However, since video streaming can consume enormous amount of resources, resource utilization efficiency in UAV communication network has to be improved before the UAV system can share videos with different users stably and reliably. Network function virtualization (NFV) have been widely applied into the design of communication networks. NFV technology allows for the provision of software network or data processing blocks known as virtual network functions (VNFs) which may be easily deployed on virtualized hardware in cloud networks, such that user requests may be processed by virtual machines (VMs) running on server nodes (server nodes). In such way, dynamic programmability, reuse, and cost reduction in UAV communication networks may be implemented, and the resource utilization of UAV communication network may be improved. In an NFV environment, a service function chain (SFC) may include a plurality of VNFs concatenated in a predefined order, which may be tasked with accomplishing users' various SFC requests (SFCRs). SFCRs may be configured to represent user service requests for video sharing from UAVs. Corresponding to SFCs, each SFCR may concatenate several VNF requests (VNFRs) in an ordered sequence.

In practical applications, the cloud network may always receive hundreds or even thousands of SFCRs. Therefore, the mapping of SFCRs (also called VNF placement) is a pivotal but challenging issue for service providers of the cloud network, where both objectives of guaranteeing delay constraints of SFCRs and minimizing resource consumption should be considered. In the cloud network, the VNF requests of the users may be processed by the VMs which are realized by NFV technology and instantiated in server nodes.

### BRIEF SUMMARY OF THE DISCLOSURE

One aspect of the present disclosure provides a method of virtual network function (VNF) placement for mapping service function chain requests (SFCRs) in a cloud network, where the VNF placement includes a node mapping phase and an adjustment phase; the node mapping phase includes a node mapping stage and a link mapping stage; and the cloud network includes a plurality of server nodes and a plurality of virtual links. The method includes, at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and after placing the VNFR onto the first best-ranked server node or the second best-ranked server node, selecting a source node for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

Another aspect of the present disclosure provides a system. The system includes a memory, configured to store program instructions for performing a method of virtual network function (VNF) placement for mapping service function chain requests (SFCRs) in a cloud network, where the VNF placement includes a node mapping phase and an adjustment phase; the node mapping phase includes a node mapping stage and a link mapping stage; and the cloud network includes a plurality of server nodes and a plurality of virtual links; and a processor, coupled with the memory and, when executing the program instructions, configured for: at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and after placing the VNFR onto the first best-ranked server node or the second best-ranked server node, selecting a source node for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

Another aspect of the present disclosure provides a non-transitory computer-readable storage medium, containing program instructions for, when being executed by a processor, performing a method of virtual network function (VNF) placement for mapping service function chain requests (SFCRs) in a cloud network, where the VNF placement includes a node mapping phase and an adjustment phase; the node mapping phase includes a node mapping stage and a link mapping stage; and the cloud network includes a plurality of server nodes and a plurality of virtual links. The method includes at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and after placing the VNFR onto the first best-ranked server node or the second best-ranked server node, selecting a source node for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary method of virtual network function placement for mapping service function chain requests (SFCRs) of unmanned aerial vehicle (UAV)-sourced video streaming in a cloud network according to various disclosed embodiments of the present disclosure.

FIG. 2 depicts a schematic of exemplary UAV-sourced video streaming in a cloud network according to various disclosed embodiments of the present disclosure.

FIG. 3 depicts a schematic of exemplary virtual links (paths) according to various disclosed embodiments of the present disclosure.

FIG. 4A depicts a schematic of acceptance rate comparison of an exemplary method of virtual network function placement with baselines according to various disclosed embodiments of the present disclosure.

FIG. 4B depicts a schematic of CPU (central processing unit) cost comparison of an exemplary method of virtual network function placement with baselines according to various disclosed embodiments of the present disclosure.

FIG. 4C depicts a schematic of bandwidth cost comparison of an exemplary method of virtual network function placement with baselines according to various disclosed embodiments of the present disclosure.

FIG. 4D depicts a schematic of virtual machine (VM) comparison of an exemplary method of virtual network function placement with baselines according to various disclosed embodiments of the present disclosure.

FIG. 5A depicts a schematic of window size ablation study of an exemplary method of virtual network function placement according to various disclosed embodiments of the present disclosure.

FIG. 5B depicts a schematic of fundamental resource overhead (FRO) ablation study of an exemplary method of virtual network function placement according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

In order to improve the efficiency of resource utilization, three following factors, which are important to UAV-sourced video sharing in NFV networks, are considered. Firstly, fundamental resource overheads (FROs) incurred by instantiating VMs in servers (i.e., server nodes) are considered. FRO is resource consumption to maintain basic functions of VMs for operating systems (OS), hypervisors, related libraries and the like. The FRO may include CPU (central processing unit) consumption and memory consumption, which are assumed to be constant and irrelevant with VNF requests being processed. Secondly, shareable VMs implemented by multi-tenancy technology are considered, which may allow a VM to process multiple VNFRs requesting videos of identical type. In UAV-sourced video streaming, videos from different UAVs are regarded as different types of videos. A VM can process requests from multiple users but can only share videos of identical type. Thirdly, the link setup cost (LSC) of initiating VM is considered, which may be incurred by synchronizing videos from a source. A newly initiated VM for sharing videos must build a communication pathway to the gateway of the source UAV or another running VM which has videos of identical type. The LSC may incur extra bandwidth consumption over occupied links.

In existing technology, methods including reinforcement learning, genetic algorithm, node-ranking heuristics and integer programming had been implemented to place VNF instances to achieve optimization objectives. However, no previous methods had considered FRO, LSC and shareability of VMs together, which are important for sharing UAV-sourced videos in practical cloud networks.

According to various embodiments of the present disclosure, a method and a system of virtual network function (VNF) placement for mapping service function chain requests (SFCRs) in a cloud network, and a storage medium are described hereinafter.

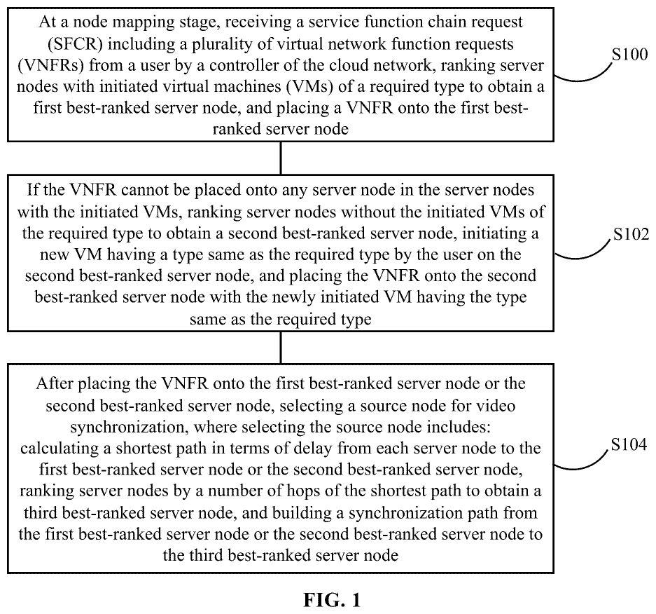

FIG. 1 depicts an exemplary method of virtual network function placement for mapping service function chain requests of unmanned aerial vehicle (UAV)-sourced video streaming in a cloud network according to various disclosed embodiments of the present disclosure. Referring to FIG. 1, the method of virtual network function placement for mapping service function chain requests of UAV-sourced video streaming may include following exemplary steps.

The VNF placement includes a node mapping phase and an adjustment phase; the node mapping phase includes a node mapping stage and a link mapping stage; and the cloud network includes a plurality of server nodes and a plurality of virtual links.

In S100, at the node mapping stage, a SFCR including a plurality of virtual network function requests (VNFRs) is received from a user by a controller of the cloud network, server nodes with initiated virtual machines (VMs) of a required type are ranked to obtain a first best-ranked server node, and a VNFR is placed onto the first best-ranked server node.

In S102, if the VNFR cannot be placed onto any server node in the server nodes with the initiated VMs, server nodes without the initiated VMs of the required type are ranked to obtain a second best-ranked server node, a new VM of a type same as the required type is initiated by the user on the second best-ranked server node, and the VNFR is placed onto the second best-ranked server node with the newly initiated VM having the type same as the required type.

In S104, after placing the VNFR onto the first best-ranked server node or the second best-ranked server node, a source node is selected for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

In one embodiment, the method further includes, at the link mapping stage, for each virtual link, determining shortest paths in terms of delay between the server node for placing the VNFR and the server node for placing another VNFR; and selecting a path with desirable bandwidth, from the shortest paths, as a physical path for mapping each virtual link.

In one embodiment, the method further includes, at an adjustment phase, ranking all initiated VMs by resource utilization and moving the VNFR to another VM with a highest resource utilization.

In one embodiment, ranking the server nodes with the initiated VMs of the required type to obtain the first best-ranked server node includes ranking the server nodes with the initiated VMs of the required type according to a number of hops to a server node where a previous VNFR is placed.

In one embodiment, the method further includes, for server nodes with a same number of hops, ranking the server nodes with the same number of hops by a sum of bandwidth utilization.

In the present disclosure, the VNF placement problem for mapping SFCRs into the cloud network in the context of sharing UAV-sourced videos is formulated. To be more practical, FRO, LSC and shareability of VMs may be configured. Moreover, redundant VMs with low resource utilization may be released, which may save more network resources. The VNF placement problem may be mathematically formulated as an integer linear programming (ILP) model. The objectives may be to minimize the consumptions of bandwidth and server (node) resources, under the constraints of availability of link and server (node) resources and delay requirement. The VNF placement problem is proven to be NP-hard. Therefore, a polynomial-time heuristic approach (method) is provided to determine a near optimal solution.

In the problem formulation, FRO, LSC and shareability of VMs (basic requirements of running VMs) may be considered but ignored in the existing technology.

To solve the VNF placement problem, a node ranking-based heuristic method (UAV-MA (mapping/adjustment)) may be configured for UAV-sourced video streaming, which may include an SFCR mapping phase to map SFCRs onto server nodes and an adjustment phase to release VMs with low resource utilization. Compared with the existing technology, the method provided in the present disclosure may effectively outperform benchmarks in terms of server nodes and link resource consumption, initiated server nodes, and resource utilization.

According to various embodiments of the present disclosure, a system model is described herein. An undirected graph G=(N∪S, E) may be configured to represent the substrate network topology of the cloud network, where S denotes a set of gateways for transmitting videos from UAVs, N denotes a set of server nodes, and E denotes a set of links in the cloud network. F may be configured to denote a set of total SFCRs of users, and a 3-tuple (V_{f}, E_{f}, Dₘₐₓ^{f}) may be configured to describe the SFCR f.

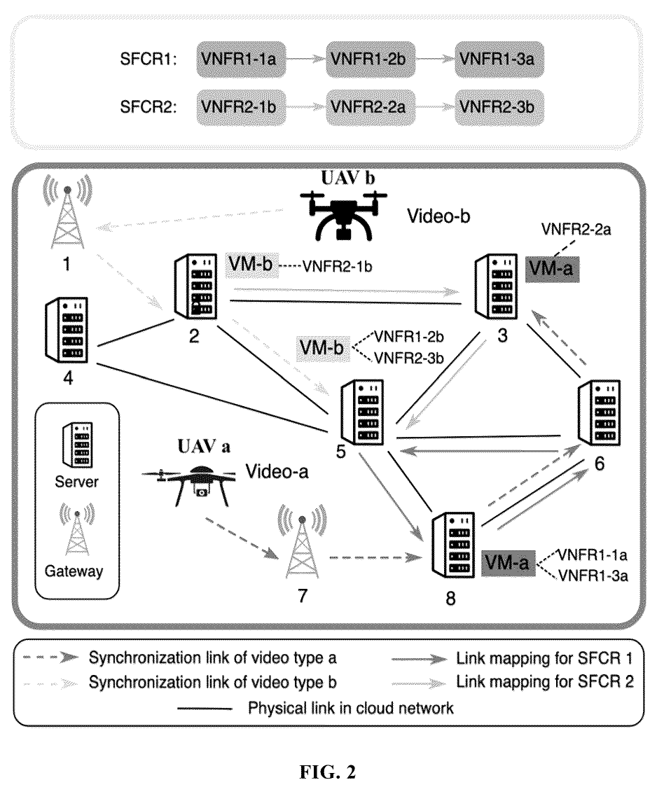

FIG. 2 depicts a schematic of exemplary UAV-sourced video streaming in a cloud network according to various disclosed embodiments of the present disclosure. A typical VNF placement example is shown in FIG. 2. Solid black lines in FIG. 2 represent physical links among servers (server nodes) in the cloud network. Two UAVs (i.e., a and b) may transmit corresponding videos (denoted as video-a and video-b) to the cloud network via gateways. Two user requests (i.e., SFCR1 and SFCR2) may include multiple VNFRs requesting videos from UAV a and UAV b, where VNFR x-yz denotes the y-th VNFR of SFCRx requesting type-z videos. A feasible solution for mapping such two SFCRs shown in FIG. 2 may include node mapping and link mapping. For the node mapping, VNFRs of SFCR1 may be placed on server nodes 8, 5 and 8; and VNFRs of SFCR2 may be placed on server nodes 2, 3 and 5. Two type-a (b) VMs for sharing type-a (b) videos may be initiated on server nodes 8 and 3 (2 and 5). For the link mapping, solid arrows show the mapping of virtual links in SFCR1 (SFCR2). Dashed arrows represent the paths for synchronizing videos in VMs with UAVs which incur LSCs of initiated VMs. Synchronizing video-a (b) may take one (two) physical link(s).

According to various embodiments of the present disclosure, corresponding notations are summarized in Table I as the following:

TABLE I

| | |
|---|---|
| Parameters | Description |

Network

| | |
|---|---|
| N | Set of server nodes in the cloud network |
| S | Set of gateways |
| E | Set of physical links in the cloud network |
| u, w | Two server nodes in the cloud network |
| (u, w) | Physical link between u and w |

SFCR

| | |
|---|---|
| F | Set of SFCRs |
| V_{f} | Set of VNFRs of SFCR f |
| E_{f} | Set of virtual links among VNFRs of SFCR f |
| ⊖ | Number of video (VM) types, |
| | and θ ∈ {0, 1, ... , ⊖ − 1} is one type |
| ${cpu}_{\overline{u}}^{f} , {mem}_{\overline{u}}^{f}$ | CPU and memory consumption required by VNFRs ū in SFCRs f |
| ${b}_{( \overline{u} , \overline{w} )}^{f}$ | Bandwidth consumption of the virtual link from VNFRs ū to w̅ of SFCR f |
| ${k}_{\overline{u} , θ}^{f}$ | Whether the VNFR ū in SFCR f requires a type-θ video |
| Dₘₐₓ^{f} | Maximum tolerable delay of SFCR f |

System

| | |
|---|---|
| ${cpu}_{θ}^{FRO} , m e {m}_{θ}^{FRO}$ | CPU and memory FROs for initiating a type-θ VM |
| ${b}_{θ}^{L S C}$ | The link setup cost (LSC) for initiating a type-θ VM |
| CPUᵤ, MEMᵤ | Capacities of CPU and memory |
| | resources at server u |
| B_{(u, w)} | Bandwidth capacity of physical link (u, w) |
| b_{(u, w)} | Remaining bandwidth of physical link (u, w) |
| N_{θ} | Servers which have initiated a type-θ VM |
| d_{(u, w)} | The delay of the physical link (u, w) |

Variables

| | |
|---|---|
| ${x}_{\overline{u} , u}^{f}$ | Whether the VNFR ū of SFCR f is placed onto the server u |
| ${l}_{( ι ι , w )}^{f , ( \overline{u} , \overline{w} )}$ | Whether the virtual link (ū, w̅) of SFCR f is placed onto the physical link (u, w) |
| ${y}_{u}^{θ}$ | Whether a type-θ VM is initiated on server u |
| ${s}_{u , w}^{θ}$ | Whether the type-θ VM on server u is synchronizing videos with server or gateway w |
| ${β}_{( a , b )}^{θ , ( u , w )}$ | Whether the synchronization path from server u to w occupies on the physical link (a, b) |

The first constraint may be to guarantee that one and only one server node is selected to host a VNFR of an SFCR as the following:

$${\sum }_{u ∈ N} {x}_{\overline{u} , u}^{f} = 1 , \overline{u} ∈ {V}_{f} \qquad ( 1 )$$

The variable denoting whether a type-θ VM is required at a server node u may be defined as:

$${y}_{u}^{θ} = \{ \begin{matrix}1 , {\sum }_{f ∈ F} {\sum }_{∀ \overline{u} ∈ {V}_{f}} {x}_{\overline{u} , u}^{f} \cdot {k}_{\overline{u} , θ} \geq 1 \\ 0 , else\end{matrix} \qquad ( 2 )$$

where ∀u∈N,

$${k}_{\overline{u} , θ}^{f}$$

denotes whether VNFR ū in SFCR f requires a type-θ VM.

The CPU and memory consumption of FROs at the server node u may be expressed as:

$${\sum }_{θ ∈ Θ} {cpu}_{θ}^{FRO} \cdot {y}_{u}^{θ} and {\sum }_{θ ∈ Θ} {mem}_{θ}^{FRO} \cdot {y}_{u}^{θ} .$$

The LSC for initiating VMs at the server node u may be expressed as:

$${\sum }_{θ ∈ Θ} {\sum }_{w ∈ N} {\sum }_{( x , v ) ∈ E} {b}_{θ}^{LSC} \cdot {y}_{u}^{θ} \cdot {s}_{u , w}^{θ} \cdot {β}_{( x , v )}^{θ , ( u , w )} .$$

The server (node) resource constraints may be formulated as the following:

$${\sum }_{∀ f ∈ F} {\sum }_{∀ \overline{u} ∈ {V}_{f}} {cpu}_{\overline{u}}^{f} \cdot {x}_{\overline{u} , u}^{f} + {\sum }_{∀ θ ∈ Θ} {cpu}_{θ}^{FRO} \cdot {y}_{u}^{θ} \leq {CPU}_{u} , u ∈ N \qquad ( 3 )$$

$${\sum }_{∀ f ∈ F} {\sum }_{∀ \overline{u} ∈ {V}_{f}} {mem}_{\overline{u}}^{f} \cdot {x}_{\overline{u} , u}^{f} + {\sum }_{∀ θ ∈ Θ} {mem}_{θ}^{FRO} \cdot {y}_{u}^{θ} \leq {MEM}_{u} , u ∈ N \qquad ( 4 )$$

where the first term on the left hand side (LHS) denotes the resource consumed by VNFRs, and the second term of LHS denotes the resource consumed by FROs. The link mapping variable may be defined as the following:

$${l}_{( u , w )}^{f , ( \overline{w} )} = \{ \begin{matrix}1 , & ( \overline{u} , \overline{w} ) is mapped on ( u , w ) \\ 0 , & else\end{matrix} \qquad ( 5 )$$

Then, the link resource constraint may be formulated as the following:

$${\sum }_{θ ∈ Θ , a ∈ N , b ∈ N} {b}_{θ}^{LSC} \cdot {y}_{a}^{θ} \cdot {s}_{a , b}^{θ} \cdot {β}_{u , w}^{θ , ( a , b )} + {\sum }_{∀ f ∈ F , ∀ ( \overline{u} , \overline{w} ) ∈ {E}_{f}} {b}_{\overline{u} , \overline{w}}^{f} \cdot {l}_{( u , w )}^{f , ( \overline{u} , \overline{w} )} \leq {B}_{( u , w )} , ( u , w ) ∈ E \qquad ( 6 )$$

where the first term on LHS denotes the bandwidths consumed by the synchronization path of initiated VMs (i.e., LSC), and the second term of LHS denotes the bandwidth cost of placed VNFRs.

In order to preserve the flow conservation in mapping SFCRs, the constraints may be imposed as the following:

$${\sum }_{w ∈ N , ( u , w ) ∈ E} {l}_{( u , w )}^{f , ( \overline{u} , \overline{w} )} - {\sum }_{w ∈ N , ( w , u ) ∈ E} {l}_{( w , u )}^{f , ( \overline{u} , \overline{w} )} = {x}_{\overline{u} , u}^{f} - {x}_{\overline{w} , u}^{f} , ( \overline{u} , \overline{w} ) ∈ {E}_{f} , u ∈ N , f ∈ F \qquad ( 7 )$$

Above-mentioned equation may ensure that the mapped path of each virtual link is consecutive in the cloud network. Then, it needs to formulate the constraint for video synchronization where each initiated type-θ VM must be connected to one and only one server node which contains another type-θ VM or the gateway of the UAV producing type-θ videos, as the following:

$${\sum }_{w ∈ N ⋃ S} {s}_{u , w}^{θ} \cdot {y}_{w}^{θ} - {y}_{u}^{θ} = 0 , and {s}_{u , u} = 0 , ∀ θ ∈ Θ , ∀ u ∈ N \qquad ( 8 )$$

$$where {s}_{u , u}^{θ} = 0$$

guarantees that any VM cannot synchronize videos with itself, and

$${y}_{w}^{θ} = 1$$

if w is the gateway or the UAV producing type-θ videos. To ensure the consecutiveness of synchronization path, the constraint may be defined as the following:

$$∀ x , v , u ∈ N ⋃ S , ∀ θ ∈ Θ , {\sum }_{w ∈ N ⋃ S , ( u , w ) ∈ E} {β}_{( u , w )}^{θ , ( x , v )} - {\sum }_{w ∈ N ⋃ S , ( w , u ) ∈ E} {β}_{( w , u )}^{θ , ( x , v )} = {y}_{x}^{θ} \cdot 1 \{ x = u \} - {y}_{v}^{θ} \cdot {s}_{x , v}^{θ} \cdot 1 \{ v = u \} \qquad ( 9 )$$

where 1{⋅} denotes an indicator function. Finally, for each SFCR, total delay during the transmission of its VNFRs should be less than the maximum tolerable delay, which may yield the following constraint:

$${\sum }_{( \overline{u} , \overline{w} ) ∈ {E}_{f} , ( u , w ) ∈ E} {d}_{( u , w )} \cdot {l}_{u , w}^{f , ( \overline{u} , \overline{w} )} \leq {D}_{max}^{f} , ∀ f ∈ F \qquad ( 10 )$$

Based on the above, the objectives of the VNF placement are described hereinafter. The first objective may be to minimize the node resource consumption, including CPU consumption and memory consumption, which may be formulated as the following:

$${Cost}_{CPU} = {\sum }_{f ∈ F} {\sum }_{\overline{u} ∈ {V}_{f}} {\sum }_{u ∈ N} {cpu}_{\overline{u}}^{f} \cdot {x}_{\overline{u} , u}^{f} + {\sum }_{θ ∈ Θ} {\sum }_{u ∈ N} {cpu}_{θ}^{FRO} \cdot {y}_{u}^{θ} \qquad ( 11 )$$

$${Cost}_{MEM} = {\sum }_{\overline{u} ∈ {V}_{f}} {\sum }_{u ∈ N} {mem}_{\overline{u}}^{f} \cdot {x}_{\overline{u} , u}^{f} + {\sum }_{θ ∈ Θ} {\sum }_{u ∈ N} {mem}_{θ}^{FRO} \cdot {y}_{u}^{θ} \qquad ( 12 )$$

The second objective may be to minimize the bandwidth consumption by virtual links of the SFCRs and LSC of initiated VMs, which may be expressed as the following:

$${Cost}_{BW} = {\sum }_{f ∈ F} {\sum }_{( \overline{u} , \overline{w} ) ∈ {E}_{f}} {\sum }_{( u , w ) ∈ E} {b}_{( \overline{u} , \overline{w} )}^{f} \cdot {l}_{( u , w )}^{f , ( \overline{u} , \overline{w} )} + {\sum }_{( u , w ) ∈ E} {\sum }_{θ ∈ Θ} {\sum }_{a ∈ N} {\sum }_{b ∈ N ⋃ S} {b}_{θ}^{LSC} \cdot {y}_{a}^{θ} \cdot {s}_{a , b}^{θ} \cdot {β}_{( u , w )}^{θ , ( a , b )} \qquad ( 13 )$$

Therefore, the objective of the VNF placement may be formulated as the following:

$$\begin{matrix}min \\ s . t .\end{matrix} \begin{matrix}α {Cost}_{CPU} + γ \\ \end{matrix} \begin{matrix}{Cost}_{MEM} + ρ {Cost}_{BW} \\ Equations ( 1 ) - ( 13 )\end{matrix} \qquad ( 14 )$$

where α, γ and ρ denote tunable hyper-parameters. The above optimization may formulate the VNF placement as an integer linear programming model.

Due to the fact that the VNF placement formulated above is NP-hard, obtaining the optimal solution of VNF placement may be NP-hard. When the problem scale is large, it is infeasible to obtain the optimal solution in a reasonable time by using optimization solver. Therefore, a polynomial-time heuristic approach may be provided to solve above-mentioned VNF placement.

The heuristic approach provided is based on node-ranking method. The node-ranking method may include a node mapping stage and a link mapping stage. The node importance ranking approach may be mainly employed to evaluate the importance of the substrate nodes (server nodes) and virtual nodes (VNFRs) to finish the node mapping stage; and then the K-shortest path approach may be configured to perform the link mapping stage. The UAV-MA method provided in embodiments of the present disclosure may include an SFCR mapping phase and an adjustment phase. In the mapping phase, the group of newly arrived SFCRs in each time window may be configured as input to derive mapping schemes. For example, VNFRs of SFCRs may be first tried to be placed onto server nodes with compatible VMs; and if unsuccessful, new VMs may be tried to be initiated on other server nodes to process VNFRs. In the adjustment phase, initiated VMs may be periodically checked and released with low resource utilization.

According to various embodiments of the present disclosure, the SFCR mapping phase is described in detail hereinafter.

For mapping each SFCR, since each SFCR includes concatenated VNFRs in a pre-defined order, the VNFRs of each SFCR may be mapped from the beginning to the end. The SFCR mapping approach may be based on node ranking heuristic which may include the node mapping stage and the link mapping stage.

In the node mapping stage, a hop-based node-ranking metric may be configured to rank and select server nodes. For example, when placing a VNFR u of an SFCR f, the server nodes may be first ranked according to the number of hops to the server node u′ where previous VNFR ū′ is placed. Incurred by virtual link (ū′, ū), the amount of bandwidths consumed by VNFR ū may be determined by the number of hops to previously placed VNFR ū′. Therefore, the server nodes closer to u′ may have priority in mapping decision. Then, among server nodes with same number of hops to u′, these server nodes may be ranked according to NRM (node resource management) metric, defined as the following:

$$NRM ( u ) = ( {cpu}_{u} + {mem}_{u} ) \times ( {\sum }_{( u , w ) ∈ E} {b}_{( u , w )} + {\sum }_{( u , w ) ∈ E} {b}_{( w , u )} ) \qquad ( 15 )$$

NRM may be the product of node resources and bandwidth resource of adjacent links. According to the ranking metric disclosed above, the best ranked server node may be selected to process the VNFR ū. Since the cloud network considered is on the ground, the transmission delays of physical links may not have significant differences. Therefore, the hop-based approach may not increase the violations of delay constraint.

In the node mapping stage, when placing a type-θ VNFR ū, the VNFR ū may be first tried to be placed onto server nodes with initiated type-θ VMs denoted as Ne. Server nodes in Ne may be ranked by the hop-based node-ranking metric disclosure above, and the VNFR ū may be tried to be placed onto server nodes in Ne in the ranked order.

However, if the VNFR ū cannot be placed onto any of server nodes in Ne, a new type-θ VM may be initiated on a server node not in N_{θ}. In such case, the hop-based node-ranking approach may be configured to rank the server nodes which do not have type-θ VM (i.e., the server nodes in N-N_{θ}), and the VNFR u may be tried to be placed onto server nodes ranked in such order. The gateway of type-θ video may be denoted as go E S. Then, when the VNFR ū can be placed onto a server node uₙ in N-N_{θ} and start a new type-θ VM at such server node, a source may also need to be selected from the server nodes in N_{θ}∪{g_{θ}} to synchronize the videos in uₙ. The hop-based link-ranking metric may be configured to select a source node from N_{θ}∪{g_{θ}} for the type-θ VM on uₙ. For example, the shortest path may be first calculated in terms of delay from every node in uₛ∈N_{θ}∪{g_{θ}} to uₙ, denoted as p(uₙ,uₛ). Subsequently, the server nodes, for example, ∀uₛ∈N_{θ}∪{g_{θ}}, may be ranked by the number of hops of corresponding shortest paths p(uₙ,uₛ). For server nodes with same number of hops, the server nodes may be further ranked by the sum of bandwidth utilization of physical links along p(uₙ,uₛ). The bandwidth utilization of a physical link may be consumed bandwidth divided by the bandwidth capacity, for example,

$$1 - \frac{{b}_{( u , w )}}{{B}_{( u , w )}} .$$

The reason to consider the number of hops is that the LSC for synchronization of the VM may be determined by the number of hops of corresponding synchronization path. Incorporating bandwidth utilization into ranking herein may be to balance the link mapping and avoid the congestion caused by synchronization paths. The detailed steps of node mapping stage of SFCR mapping are listed in Algorithm 1 as the following:

Algorithm 1 Node mapping stage of SFCR mapping

Require: ū: the VNFR to be placed in type θ; [symbol] : VNFRs which are

| | connected with ū and have been placed; |
|---|---|
| 1: | Store nodes with running type-θ VMs in N_{θ}; |
| 2: | Rank nodes in N_{θ} by the hop-based node-ranking metric, and denote |
| | the |
| 3: | for u E {τ₀, τ₁, . . . ; τ_{\|N}_{_{θ}}_{\|} − 1} do |
| 4: | if VNFR ū can be placed on server u then |
| 5: | $Set {x}_{\overline{u} , u}^{f} = 1 ;$ |
| 6: | $Return {x}_{\overline{u} , u}^{f} and None ; \% No new VM is initiated$ |
| 7: | end if |
| 8: | end for |
| 9: | % Initiate a new type-θ VM |
| 10: | Rank servers in N − N_{θ} by the hop-based node-ranking metric with |
| | the |
| | $ranked order denoted as {τ}_{0}^{′} , {τ}_{1}^{′} , … , {τ}_{\vert N - {N}_{θ} \vert - 1}^{′} ;$ |
| 11: | $for {u}_{n} ∈ \{ {τ}_{0}^{′} , {τ}_{1}^{′} , … , {τ}_{\vert N - {N}_{θ} \vert - 1}^{′} \}$ |
| | do |
| 12: | if VNFR ū can be placed onto uₙ by starting a new type-θ VM |
| | then |
| 13: | Start a new type-θ VM at uₙ; |
| 14: | $Set {x}_{\overline{u} , {u}_{n}}^{f} = 1 and {y}_{{u}_{n}}^{θ} = 1 ;$ |
| 15: | Calculate shortest paths in terms of delay from servers in |
| | N_{θ}∪{g_{θ}} to uₙ; |
| 16: | Rank servers in N_{θ}∪{g_{θ}} by shortest paths based on the hop- |
| | based link-ranking metric, and denote the ranked order as |
| | as \tilde{τ}₀, \tilde{τ}₁, . . . ; \tilde{τ}_{\|N}_{_{θ}}_{\|} − 1; |
| 17: | for us E {\tilde{τ}₀, \tilde{τ}₁, . . . ; \tilde{τ}_{\|N}_{_{θ}}_{\|} − 1} do |
| 18: | if Synchronization path can be built from uₛ to uₙ then |
| 19: | $Set {s}_{{u}_{n} , {u}_{s}}^{θ} = 1 and {β}_{( u , w )}^{θ , ( {u}_{n} , {u}_{s} )} = 1 for links ( u , w )$ |
| | along the synchronization path; |
| 20: | $Return {x}_{\overline{u} , {u}_{n}}^{f} and ( {y}_{{u}_{n}}^{θ} , {s}_{{u}_{n}}^{θ} , {β}^{θ , ( {u}_{n} , {u}_{s} )} )$ |
| 21: | end if |
| 22: | end for |
| 23: | end if |
| 24: | end for |

In the link mapping stage, for every virtual link (ū, w̅) where w̅ denotes another VNFR, the K shortest paths may be first determined in terms of the delay between the server nodes where ū and w̅ are placed, and the path with sufficient bandwidth may be selected as the physical path for mapping the virtual link (ū, w̅).

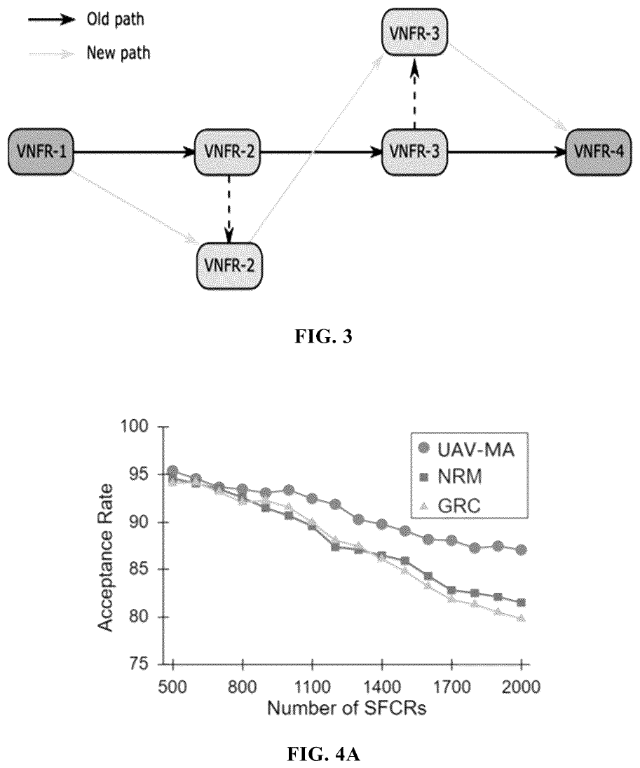

In the adjustment phase, all VMs may be ranked by resource (CPU and memory) utilization which is the ratio between consumed resources and corresponding FRO costs. The VMs with 10% bottom resource utilization may be tried to be released by moving VNFRs placed in such VMs to other VMs with higher resource utilization. When moving the VNFR ū, for node mapping, the hop-based node-ranking metric may be first configured to find the server node which has compatible VM to the serve node ū. Then, for link mapping, the k-shortest path may be configured to re-route the physical paths for the virtual links connected with \vec{u} in SFCR. FIG. 3 depicts a schematic of exemplary virtual links (paths) according to various disclosed embodiments of the present disclosure. An example of adjustment is shown in FIG. 3. Referring to FIG. 3, VNFR-2 and VNFR-3 may be moved to new corresponding server nodes, and connected virtual link may be re-routed to form new path.

The virtual network function placement method provided in embodiments of the present disclosure may be implemented by Python. The implementation may be conducted on a laptop with a 2.9-GHz Intel Core i7 processor and 32 GB memory. Waxman network topology may be configured to generate the cloud network including about 100 server nodes. The resources of server nodes and the bandwidths of links in the physical network may be uniformly distributed from 50 to 100 units. In each trial, SFCRs may arrive at the system sequentially according to a Poisson process with an average arriving rate of 25 per 100 time units, but not be processed sequentially. Arriving SFCRs in a time window may be placed together as a batch.

According to various embodiments of the present disclosure, 5 types of VNFRs may be configured in the evaluation. For each VM, the values of CPU FRO and memory FRO cpu _{θ}^{FRO} and mem_{θ}^{FRO}) may be set to 10; the link setup cost (LSC) for synchronization (b_{θ}^{LSC}) may be set to 10. Corresponding parameters are presented in Table II as the following:

TABLE II

| Parameters | Description | Value |
|---|---|---|
| CPUᵤ | CPU capacity of a server u | [50, 100] |
| MEMᵤ | Memory capacity of a server u | [50, 100] |
| B_{(u, w)} | Bandwidth capacity of a physical link | [50, 100] |
| ${cpu}_{θ}^{FRO}$ | CPU FRO of a type-θ VM | 10 |
| $me {m}_{θ}^{FRO}$ | Memory FRO of a type-θ VM | 10 |
| ${b}_{θ}^{LSC}$ | LSC of a type-θ VM | 20 |
| ${cpu}_{\overline{u}}^{f}$ | CPU consumption of VNFR ū | [5, 50] |
| $m e {m}_{\overline{u}}^{f}$ | Memory consumption of VNFR ū | [5, 50] |
| ${b}_{( \overline{u} , \overline{w} )}^{f}$ | Bandwidth consumption of a virtual link (ū, w̅) in SFCR f | [0, 50] |
| d_{(u, w)} | Delay on a physical link (u, w) | [2, 5] |
| ${D}_{max}^{f}$ | Maximum tolerable delay of SFCR f | [50, 100] |

The first baseline may be direct application of NRM approach, without considering the extra cost for initiating new VMs. VNFRs may be directly placed by ranking server nodes in the cloud network according to NRM.

The second baseline may be GRC (global resource capacity) approach, which is a heuristic-based approach based on global resource capacity to map VNFs onto physical server nodes. Both NRM and GRC approaches may initiate VMs when selected server nodes do not have compatible VMs, without specific consideration on the FRO and LSC of VMs.

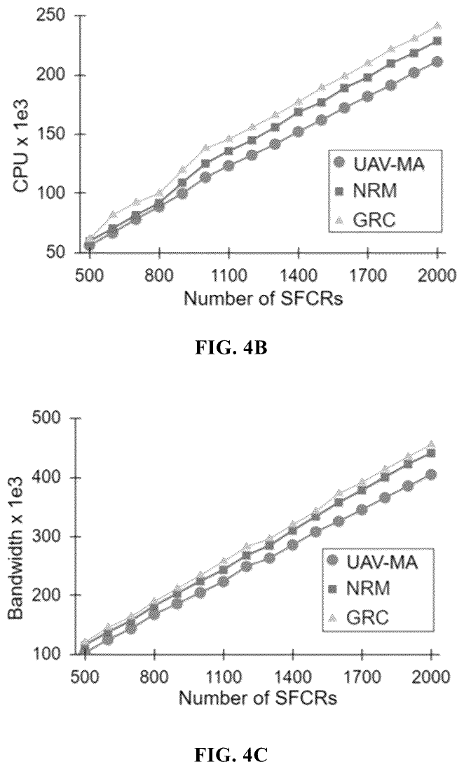

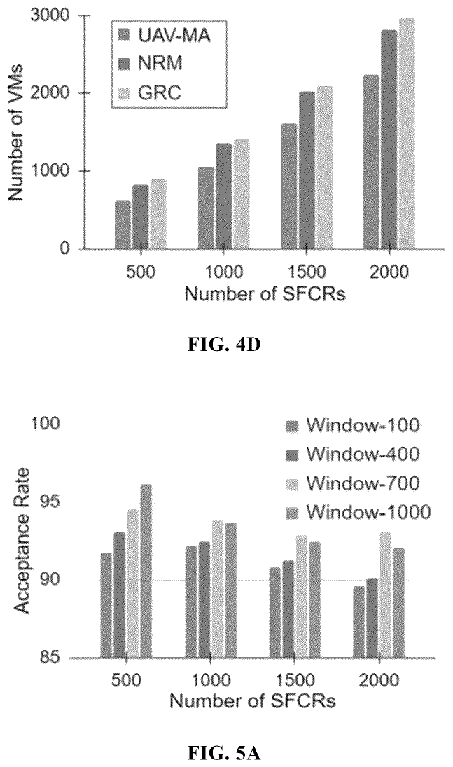

The UAV-MA method (virtual network function placement) provided by embodiments of the present disclosure may be compared with baselines in FIGS. 4A-4D. FIG. 4A depicts a schematic of acceptance rate comparison of an exemplary method of virtual network function placement with baselines according to various disclosed embodiments of the present disclosure; FIG. 4B depicts a schematic of CPU cost comparison of an exemplary method of virtual network function placement with baselines according to various disclosed embodiments of the present disclosure; FIG. 4C depicts a schematic of bandwidth cost comparison of an exemplary method of virtual network function placement with baselines according to various disclosed embodiments of the present disclosure; and FIG. 4D depicts a schematic of VM comparison of an exemplary method of virtual network function placement with baselines according to various disclosed embodiments of the present disclosure. Referring to FIGS. 4A-4D, all the results may be the average of 10 random seeds (runs). The acceptance rate may mean the ratio of successful VNF placements meeting the service level agreement (SLA) including resource and delay constraints. The CPU and bandwidth consumption may be the amount of CPU and bandwidths consumed by placed VNFRs. FIG. 4D compares the number of initiated VMs. As shown in FIGS. 4A-4D, it can be seen that the UAV-MA method (virtual network function placement) provided by embodiments of the present disclosure may outperform both above-mentioned baselines in terms of acceptance rate, resource consumption and number of initiated VMs. When selecting server nodes for new VMs, the UAV-MA method provided by embodiments of the present disclosure may consider both FRO and LSC of initiating new VMs, which are ignored in the baselines (baseline methods, such as NRM and GRC). Since more practical factors are taken into consideration into the UAV-MA method, the baselines may be outperformed by the UAV-MA method, as shown in FIGS. 4A-4D.

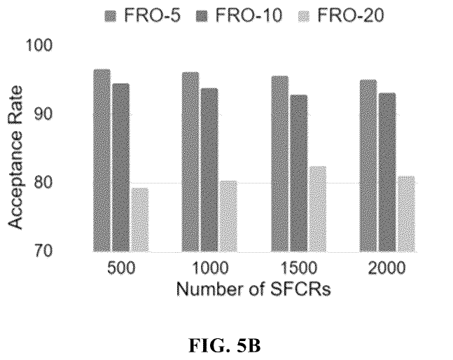

The ablation study of the UAV-MA method (virtual network function placement) provided by embodiments of the present disclosure is shown in FIGS. 5A-5B. FIG. 5A depicts a schematic of window size ablation study of an exemplary method of virtual network function placement according to various disclosed embodiments of the present disclosure; and FIG. 5B depicts a schematic of FRO ablation study of an exemplary method of virtual network function placement according to various disclosed embodiments of the present disclosure. First, the performance of different choices of the window sizes during which the newly arrived SFCRs are mapped together may be evaluated. Various window sizes over different number of coming SFCRs may be compared. As shown in FIG. 5A, when window size is larger, the performance may become desirable. However, in some cases, the performance for the window size of 700 ms may be better the performance for the window size of 1000 ms since the method provided in the present disclosure may not work best for excessively long window size. Furthermore, the performance of the method provided in the present disclosure for different values of FRO when initiating new VM may be also evaluated, as shown in FIG. 4B, where FRO is same for every type of VMs. As shown in FIG. 4B, when FRO becomes excessively large, the performance may degrade suddenly and significantly.

Various embodiments of the present disclosure provide a system. The system includes a memory, configured to store program instructions for performing a method of virtual network function (VNF) placement for mapping service function chain requests (SFCRs) in a cloud network, where the VNF placement includes a node mapping phase and an adjustment phase; the node mapping phase includes a node mapping stage and a link mapping stage; and the cloud network includes a plurality of server nodes and a plurality of virtual links; and a processor, coupled with the memory and, when executing the program instructions, configured for: at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and after placing the VNFR onto the first best-ranked server node or the second best-ranked server node, selecting a source node for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

Various embodiments of the present disclosure provide a non-transitory computer-readable storage medium, containing program instructions for, when being executed by a processor, performing a method of virtual network function (VNF) placement for mapping service function chain requests (SFCRs) in a cloud network, where the VNF placement includes a node mapping phase and an adjustment phase; the node mapping phase includes a node mapping stage and a link mapping stage; and the cloud network includes a plurality of server nodes and a plurality of virtual links. The method includes at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node; if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and after placing the VNFR onto the first best-ranked server node or the second best-ranked server node, selecting a source node for video synchronization. Selecting the source node includes calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A method of virtual network function (VNF) placement for mapping service function chain requests (SFCRs) in a cloud network, wherein the VNF placement includes a node mapping phase and an adjustment phase; the node mapping phase includes a node mapping stage and a link mapping stage; and the cloud network includes a plurality of server nodes and a plurality of virtual links, the method comprising:
at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node;
if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and
after placing the VNFR onto the first best-ranked server node or the second best-ranked server node, selecting a source node for video synchronization, wherein selecting the source node includes:
calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

2. The method according to claim 1, further including:
at the link mapping stage, for each virtual link, determining shortest paths in terms of delay between the server node for placing the VNFR and the server node for placing another VNFR; and selecting a path with desirable bandwidth, from the shortest paths, as a physical path for mapping each virtual link.

3. The method according to claim 1, further including:
at an adjustment phase, ranking all initiated VMs by resource utilization and moving the VNFR to another VM with a highest resource utilization.

4. The method according to claim 1, wherein ranking the server nodes with the initiated VMs of the required type to obtain the first best-ranked server node includes:
ranking the server nodes with the initiated VMs of the required type according to a number of hops to a server node where a previous VNFR is placed.

5. The method according to claim 1, further including:
for server nodes with a same number of hops, ranking the server nodes with the same number of hops by a sum of bandwidth utilization.

6. A system, comprising:
a memory, configured to store program instructions for performing a method of virtual network function (VNF) placement for mapping service function chain requests (SFCRs) in a cloud network, wherein the VNF placement includes a node mapping phase and an adjustment phase; the node mapping phase includes a node mapping stage and a link mapping stage; and the cloud network includes a plurality of server nodes and a plurality of virtual links; and
a processor, coupled with the memory and, when executing the program instructions, configured for:
at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node;
if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and
after placing the VNFR onto the first best-ranked server node or the second best-ranked server node, selecting a source node for video synchronization, wherein selecting the source node includes:
calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

7. The system according to claim 6, wherein the processor is further configured to:
at the link mapping stage, for each virtual link, determine shortest paths in terms of delay between the server node for placing the VNFR and the server node for placing another VNFR; and select a path with desirable bandwidth, from the shortest paths, as a physical path for mapping each virtual link.

8. The system according to claim 6, wherein the processor is further configured to:
at an adjustment phase, rank all initiated VMs by resource utilization and moving the VNFR to another VM with a highest resource utilization.

9. The system according to claim 6, wherein ranking the server nodes with the initiated VMs of the required type to obtain the first best-ranked server node includes:
ranking the server nodes with the initiated VMs of the required type according to a number of hops to a server node where a previous VNFR is placed.

10. The system according to claim 6, wherein the processor is further configured to:
for server nodes with a same number of hops, rank the server nodes with the same number of hops by a sum of bandwidth utilization.

11. A non-transitory computer-readable storage medium, containing program instructions for, when being executed by a processor, performing a method of virtual network function (VNF) placement for mapping service function chain requests (SFCRs) in a cloud network, wherein the VNF placement includes a node mapping phase and an adjustment phase; the node mapping phase includes a node mapping stage and a link mapping stage; and the cloud network includes a plurality of server nodes and a plurality of virtual links; the method comprising:
at the node mapping stage, receiving a SFCR including a plurality of virtual network function requests (VNFRs) from a user by a controller of the cloud network, ranking server nodes with initiated virtual machines (VMs) of a required type to obtain a first best-ranked server node, and placing a VNFR onto the first best-ranked server node;
if the VNFR cannot be placed onto any server node in the server nodes with the initiated VMs, ranking server nodes without the initiated VMs of the required type to obtain a second best-ranked server node, initiating a new VM having a type same as the required type by the user on the second best-ranked server node, and placing the VNFR onto the second best-ranked server node with the newly initiated VM having the type same as the required type; and
after placing the VNFR onto the first best-ranked server node or the second best-ranked server node, selecting a source node for video synchronization, wherein selecting the source node includes:
calculating a shortest path in terms of delay from each server node to the first best-ranked server node or the second best-ranked server node, ranking server nodes by a number of hops of the shortest path to obtain a third best-ranked server node, and building a synchronization path from the first best-ranked server node or the second best-ranked server node to the third best-ranked server node.

12. The storage medium according to claim 11, wherein the processor is further configured to:
at the link mapping stage, for each virtual link, determine shortest paths in terms of delay between the server node for placing the VNFR and the server node for placing another VNFR; and select a path with desirable bandwidth, from the shortest paths, as a physical path for mapping each virtual link.

13. The storage medium according to claim 11, wherein the processor is further configured to:
at an adjustment phase, rank all initiated VMs by resource utilization and moving the VNFR to another VM with a highest resource utilization.

14. The storage medium according to claim 11, wherein ranking the server nodes with the initiated VMs of the required type to obtain the first best-ranked server node includes:
ranking the server nodes with the initiated VMs of the required type according to a number of hops to a server node where a previous VNFR is placed.

15. The storage medium according to claim 11, wherein the processor is further configured to:
for server nodes with a same number of hops, rank the server nodes with the same number of hops by a sum of bandwidth utilization.
